(19) United States
(12) Patent Application Publication
(10) Pub. No.: US 2005/0028745 A1
(43) Pub. Date: Feb. 10, 2005

(54) Litter containment system

(76) Inventors: Robert A. Baillie, Manchester, NJ (US); Suzanne M. Baillie, Manchester, NJ (US)

Correspondence Address: Charles I. Brodsky, Esq., 2 Bucks Lane, Marlboro, NJ, 07746, US

(21) Appl. No.: 10/626,692

(22) Filed: Jul. 25, 2003

(51) Int. Cl. A01K 29/00

(52) U.S. Cl. 119/165

(57) ABSTRACT

A cat litter box having an entrance way opening in the side surface establishing its configuration, with the entrance way opening extending upwardly from a predetermined point above its bottom surface and including inwardly facing edge surfaces providing a brushing function in physically contacting the fur and paws of a cat constrained to enter into and exit from the litter box via the opening.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX NOT APPLICABLE

### BACKGROUND OF THE INVENTION

1. Field of the Invention

This invention relates to litter containment systems, in general, and to a new and improved construction of a cat litter box whether opened or covered, in particular.

2. Description of the Related Art

As will be appreciated by those skilled in the art, approximately 30-35% of the cat litter boxes being sold today come with a top cover of one sort or another, while about 65-70% are sold without any cover whatsoever. Whether available with a cover or not, one of the major concerns of almost all cat lovers is the litter tracking and scattering which follows from the cat's fur and paws as it exits the typical litter box construction which characterizes the prior art.

### SUMMARY OF THE INVENTION

As will become clear from the following description, a new and improved cat litter box construction according to the invention includes an entrance way opening into the enclosing side surface which establishes the configuration of the litter box, with an inwardly facing edge surface having brush means positioned to physically contact at least one of the cat's fur and paws when entering into, or exiting from, the box by way of opening. As will be described, an entrance way opening constructed according to a preferred embodiment includes three such edge surfaces—two along the side of the entrance way opening, and one along its bottom—of dimension to contact the cat's sides as its exits, with the bottom edge surface positioned a predetermined distance above the litter box's bottom surface such that if the cat were to exit by stepping onto this bottom edge surface, its paws would be cleaned as well, yet if the cat were to exit by stepping over the bottom edge surface, the brush means would rub against its underbelly. When fabricating the brush arrangement as a washable abrasive—or as such a washable plastic abrasive as ASTROTURF—, the result has been found to be not only the capture of litter that might otherwise be tracked from the box, but a grooming of the cat's fur as well, catching any loose hairs.

To attain this result, a preferred construction of the invention follows by providing the entrance way opening of a substantially 7″ width, with its bottom edge surface some 5½″ above the bottom surface of the litter box. When designing the cat litter box of the invention for use as an uncovered box, the entrance way could be provided of a height of 4½″, yielding an overall height for the litter box of some 10″.

In accordance with the teachings of the invention, a covered litter box easily follows by resting a second such box in inverted fashion atop the edge surfaces of a first box, which establishes the configuration of its lower half. A unitary entrance way opening then is provided—of the same 7″ or so width, but with an overall height of 9″ equally spaced between its then top and bottom surfaces—5½″ offset between each its top and bottom surfaces. In such construction, then, the brush arrangement provided by the top half will be seen to further groom the fur at the cat's back and upper sides, as well as containing any litter that may be carried along its fur, causing the litter to be collected in the brush and/or falling and remaining within the litter box itself.

### BRIEF DESCRIPTION OF THE DRAWINGS

These and other features of the present invention will be more clearly understood from a consideration of the following description, taken in connection with the accompanying drawings, in which:

FIG. 1 is a pictorial illustration of a pair of cat litter boxes embodying the invention separable as two separate uncovered boxes or for resting one atop the other as a covered litter box;

FIGS. 2, 3 and 4 are front, top and left side views respectively of the bottom litter box of FIG. 1, with the left side view of FIG. 4 being illustrated where the brush configuration has been removed for ease of understanding;

FIGS. 5, 6 and 7 are front, top and left side views respectively of the removably insertable brush means when constructed of a washable plastic abrasive; and

FIG. 8 is a front view of the litter box of FIG. 1 with the two separate halves coupled to provide a covered litter box according to the invention.

### DETAILED DESCRIPTION OF THE INVENTION

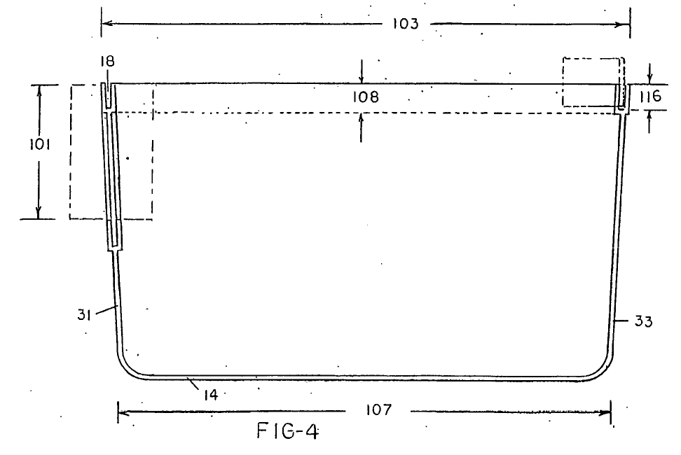

Referring to the Drawings, the covered litter box 10 of the invention includes two identical inverted halves 10A and 10B. When fabricated of plastic, each half includes an enclosing side surface 12 which establishes the configuration of the litter box in extending upwardly from its bottom surface 14 or downwardly from its top surface 16 as the case may be. A longitudinal track 18 runs along the side surface 12 to the front of the lower litter box half 10A where an entrance way opening 19A is provided to receive a removably insertable brush means 20 having ear extensions 22 for sliding into end receptacles 21 in the track 18. As more particularly indicated in FIG. 4, while the front and rear surfaces 31, 33 of the litter box half 10A substantially extend upwardly at right angles from the bottom surface 14 (and correspondingly would extend at such substantially right angles downwardly from the top surface 16 of the upper litter box half 10B when utilized in providing a covered litter box), the angulations are slightly in excess of 90° to allow nesting of one within the other when stacked for ease of shipment to a distributor in packages of 6-12 units at a time.

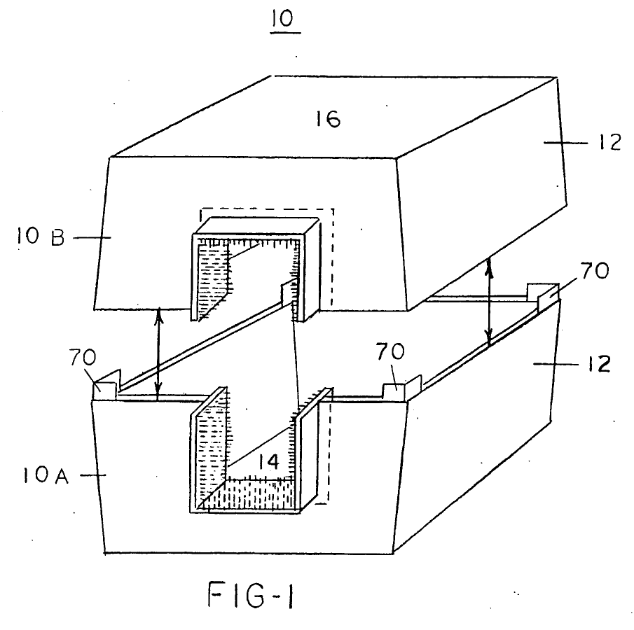

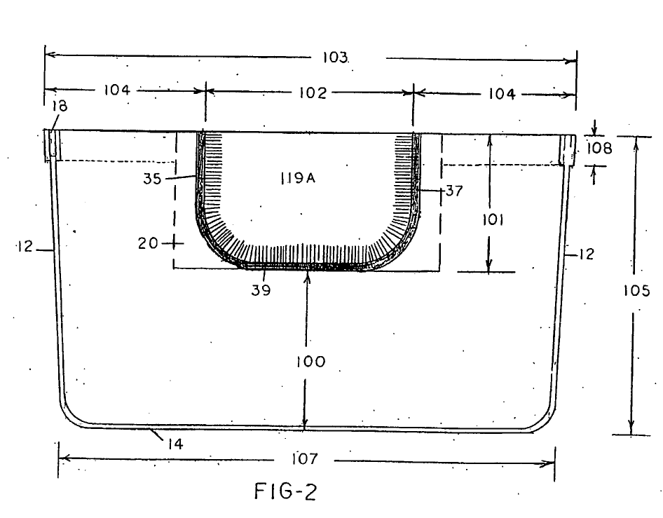

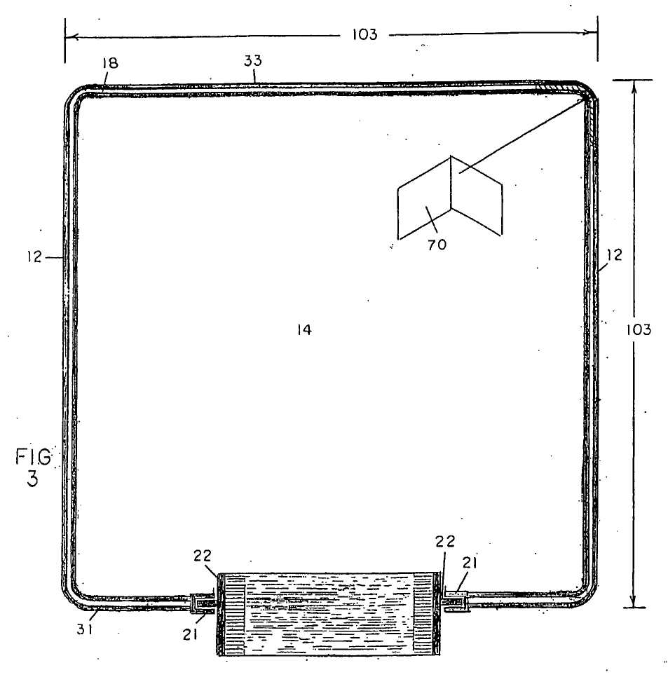

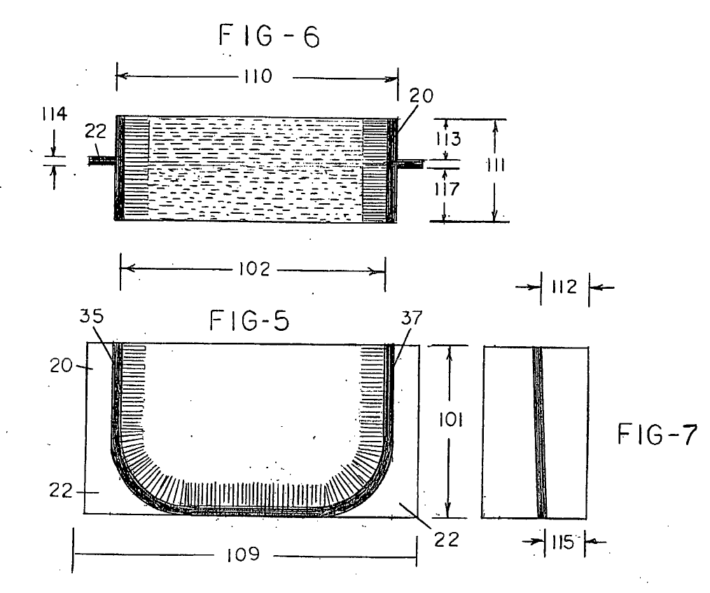

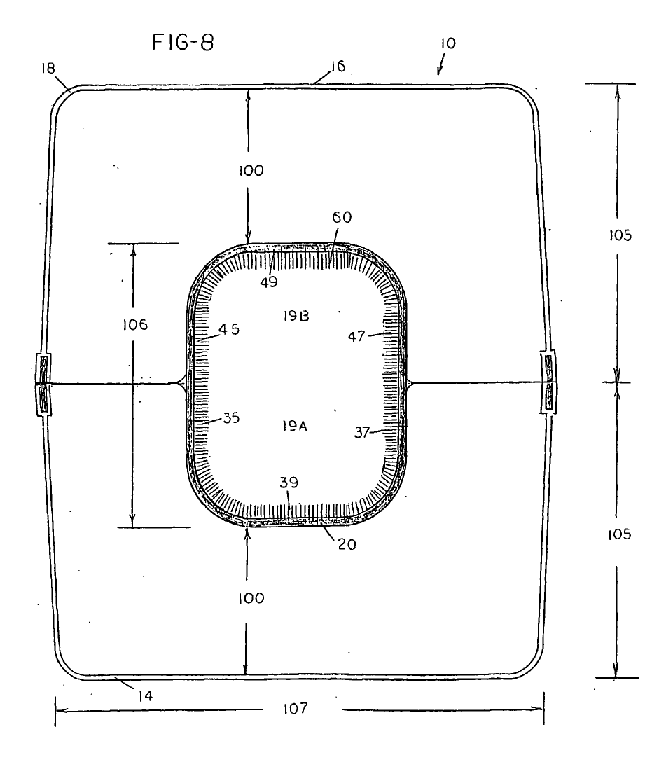

As FIGS. 2, 3, 5 and 6 illustrate, the brush means 20 form entrance way openings into and exiting from the litter box half, which include three edge surfaces—two at the sides, and one at the bottom and/or top as the case may be. At least one of these inwardly facing edge surfaces—and preferably all three—are constructed with an abrasive material positioned to physically contact body portions of a cat entering into or exiting from the litter box so formed. With the side edge surfaces 35, 37, for example, the abrasive material serves to rub against the fur on the side of the cat's body, while the bottom edge surface 39 is positioned a height 100 above the bottom surface 14 of the lower litter box half 10A in providing a surface whereby should the cat step on the edge surface 39, litter on its paws would be rubbed off, whereas should the cat step over the edge surface 39, the abrasive brush material would rub against the cat's underbelly. In either event, the litter on the body is captured within the brush to be thereafter washed and cleaned. In similar fashion, with the litter box 10B placed in position over the litter box 10A as in FIG. 1 to provide the front view of FIG. 8, such a second entrance way opening 19B is provided, whereby its own upper edge surface 49 is then positioned to contact the back of the cat exiting the litter box in capturing litter there as well as at its side edge surfaces 45, 47—to also be cleaned on washing when removing its own brush means 60 for doing so from the upper section 10B. Loose cat hairs and the litter are both then captured at the same time.

As will be appreciated by those skilled in the art, the end result would be that the lower brush arrangement 20 and the upper brush arrangement 60 are removable by means of the ear extensions 22 from the tracks 18 in the side surfaces 12 for washing and cleaning—and with the brush material being of such a washable, preferably plastic abrasive. ASTROTURF has been determined to serve preferably well as to this, to not only clean the litter but to groom the cat's fur, as well.

Reference numeral 70 in FIGS. 1, 3 and 4 identify corner pieces which seat within the track 18 of the side surface 12 of litter box 10A, for positioning litter box 10B atop it through insertion into its own corresponding track. Four such corner pieces will be seen to be utilized in accomplishing this—and in the sale of a litter box embodying the invention, four such corner pieces 70 accompany the brush means of each litter box half. Although purchase of two such litter box halves 10A and 10B would yield 8 such corner pieces, only four are utilized in combining the two boxes into the covered unit of FIGS. 1 and 8.

As will be readily understood, optimum results in containing the litter and in grooming the cat follows the inclusion of the abrasive brush material at each of the three inwardly facing edge surfaces of the entrance way opening of the litter box. Benefits will be appreciated to follow, but not as well, where only the inwardly facing side edge surfaces carry the abrasives, or where only the inwardly facing bottom (or top) edge surface is so provided. Optimum containment and grooming, however, has been achieved when all three such edge surfaces include the abrasive material (as in FIGS. 2-4), and with all six such edge surfaces so provided with the abrasive brush material when the two litter box halves 10A & 10B are so arranged (as FIG. 8). As will be appreciated, then, the advantages of the present invention will be available to those cat fanciers who are only interested in an uncovered litter box (i.e., the lower half 10A of FIGS. 2-4), or for those desirous of having a covered litter box available (i.e., with the upper half 10B of FIG. 8 in place). As will be evident, the upper half 10B could easily then be lifted out of place, for use as a second litter box lower half for a second cat.

While optimum performance has followed by providing entrance way openings of some 4½″ height and some 7″ wide, located some 5½″ from its resting surfaces 14 or 16, applicant does not wish to be limited to any such values. In a preferred embodiment of the invention for an uncovered litter box height of 10″ and a covered litter box height of 20″, both with a depth of some 17¾″, the following dimensions have proved useful:

Dimension 100 . . . 5-½″
Dimension 101 . . . 4-½″
Dimension 102 . . . 7″
Dimension 103 . . . 17-¾″
Dimension 104 . . . 5-⅜″
Dimension 105 . . . 10″
Dimension 106 . . . 9″
Dimension 107 . . . 16-½″
Dimension 108 . . . ⅞″
Dimension 109 . . . 8-¾″
Dimension 110 . . . 7-5/16″
Dimension 111 . . . 2-¾″
Dimension 112 . . . 1-¼″
Dimension 113 . . . 1″
Dimension 114 . . . ⅛″
Dimension 115 . . . 1″
Dimension 116 . . . ¾″
Dimension 117 . . . 1-⅝″

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

1. A cat litter box comprising:
a bottom surface;
an enclosing side surface upwardly extending from said bottom surface establishing the configuration of the litter box;
an entrance way opening into the litter box through said side surface, upwardly extending from a predetermined point above said bottom surface;
and with said entrance way opening having an inwardly facing edge surface including brush means positioned to physically contact at least one of the fur and paws of a cat entering into and exiting from the litter box via said opening.

2. The cat litter box of claim 1 wherein said entrance way opening has at least two inwardly facing edge surfaces, at least one of which includes said brush means for physically contacting the fur of said cat.

3. The cat litter box of claim 1 wherein said entrance way opening has three inwardly facing edge surfaces, each of which includes said brush means positioned for physically contacting at least one of the fur and paws of said cat.

4. The cat litter box of claim 1 wherein said entrance way opening extends upwardly from said predetermined point substantially to an uppermost edge of said enclosing side surface.

5. The cat litter box of claim 1 wherein said side surface upwardly extends from said bottom surface at substantially right angles thereto, and wherein said entrance way opening includes a pair of opposing side edge surfaces joined by a bottom edge surface.

6. The cat litter box of claim 5 wherein said side surface upwardly extends from said bottom surface at an angle in excess of 90° with respect thereto, and wherein said entrance way opening includes a pair of opposing side edge surfaces joined by a bottom edge surface.

7. The cat litter box of claim 5 wherein said entrance way opening extends upwardly from said bottom surface from a point substantially 5½″ above said bottom surface.

8. The cat litter box of claim 5 wherein said entrance way extends opening upwardly a distance of substantially 4½″, and wherein said pair of opposing side edge surfaces are spaced apart substantially 7″.

9. The cat litter box of claim 8 wherein said enclosing side surface extends upwardly from said bottom surface a distance of substantially 10″.

10. The cat litter box of claim 1 wherein said brush means is removably insertable within said entrance way opening for holding in place thereat.

11. The cat litter box of claim 10 wherein said brush means includes a washable abrasive.

12. The cat litter box of claim 11 wherein said brush means includes a washable plastic abrasive.

13. The cat litter box of claim 12 wherein said brush means is composed of ASTROTURF.

14. The cat litter box of claim 1, also including:
a top surface;
an enclosing side surface downwardly extending from said top surface of configuration to rest upon edge surfaces of said upwardly extending side surface;
a second entrance way opening through said downwardly extending side surface in substantial reverse orientation to said upwardly extending entrance way opening, and downwardly from a predetermined point below said top surface;
and with said second entrance way opening having an inwardly facing edge surface including brush means positioned to additionally physically contact the fur of a cat entering into and exiting from the litter box via said second opening.

15. The cat litter box of claim 14 wherein said second entrance way opening has at least two inwardly facing edge surfaces, at least one of which includes brush means positioned for physically contacting the fur of said cat.

16. The cat litter box of claim 14 wherein said second entrance way opening has three inwardly facing edge surfaces, each of which includes brush means positioned for physical contacting the fur of said cat.

17. The cat litter box of claim 16 wherein said brush means of each of said entrance way openings is removably insertable within its respective entrance way opening for holding in place thereat.

18. The cat litter box of claim 17 wherein each of said brush means includes a washable abrasive.

19. The cat litter box of claim 17 wherein each of said brush mean includes a washable plastic abrasive.

20. The cat litter box of claim 17 wherein each of said entrance way openings are substantially 4½″ in height, 7″ in width, and extend to within some 5½″ of said bottom surface and said top surface, respectively.
